(19) United States
(12) Patent Application Publication
(10) Pub. No.: US 2022/0198367 A1
(43) Pub. Date: Jun. 23, 2022

(54) EXPERT MATCHING THROUGH WORKLOAD INTELLIGENCE

(71) Applicant: INTUIT INC., Mountain View, CA (US)

(72) Inventors: Quang Nguyen, San Jose, CA (US); Divya Beeram, Newwark, CA (US); Yunqi Li, Standford, CA (US); Steven James Brown, Sunnyvale, CA (US); Neo Yuchen, Arcadia, CA (US)

(21) Appl. No.: 17/189,812

(22) Filed: Mar. 2, 2021

Related U.S. Application Data
(60) Provisional application No. 63/128,410, filed on Dec. 21, 2020.

(51) Int. Cl. G06Q 10/06; G06N 20/00

(52) U.S. Cl. CPC G06Q 10/063112; G06N 20/00; G06Q 10/0633

(57) ABSTRACT

Aspects of the present disclosure provide techniques for expert matching though workload intelligence. Embodiments include receiving a request for a support engagement. Embodiments include receiving workload data of a plurality of experts. Embodiments include determining a workload capacity of each respective expert based on the respective workload data for the respective expert. Embodiments include determining a respective estimated completion time for the support engagement for each of the plurality of experts using a machine learning model. Embodiments include determining match scores for the support engagement and each of the plurality of experts based on the estimated completion times and the workload capacities. Embodiments include selecting a given expert of the plurality of experts to handle the support engagement based on the match scores.

### CROSS REFERENCE TO RELATED APPLICATIONS

This application claims the benefit of and priority to U.S. Provisional Patent Application Ser. No. 63/128,410, filed Dec. 21, 2020, the contents of which are incorporated herein by reference in their entirety.

### INTRODUCTION

Aspects of the present disclosure relate to techniques for matching experts with customers through the use of workload intelligence.

### BACKGROUND

Every year millions of people, businesses, and organizations around the world use computer software to help manage aspects of their lives. Providers of computer software may offer live support to customers, connecting those requesting assistance with experts capable of providing the requested assistance. Live support by experts may be offered via voice, text, video, and/or the like.

When connecting a customer with an expert, a live support system must use some method of selecting an expert to whom to route the customer's request. Some systems may select the next available expert, while other systems may take into account other factors, such as the type of issue about which support is requested. However, it can be difficult to determine in advance whether a given expert will be able to adequately assist a given customer in an efficient manner. For example, without knowing in advance how much time it will take a particular expert to assist a customer with a particular request, existing techniques may match a customer with an expert that cannot effectively handle the customer's request in view of the expert's existing workload. Furthermore, existing techniques may take into account only a limited number of customer and expert attributes when matching, which may result in a low-quality match. While some techniques involve manual matching in real-time by professionals, these techniques require dedicated personnel and are difficult to scale.

What is needed is a solution for improved automated matching of customers with experts that reduces ineffective and inefficient matches.

### BRIEF SUMMARY

Certain embodiments provide a method for expert matching through workload intelligence. The method generally includes: receiving, from a user, a request for a support engagement comprising information related to the request; receiving, for each respective expert of a plurality of experts, respective workload data comprising information related to current engagements of the respective expert; determining, for each respective expert of the plurality of experts, a respective workload capacity of the respective expert based on the respective workload data for the respective expert; determining, for each respective expert of the plurality of experts, a respective estimated completion time for the support engagement based on a respective output from a machine learning model, wherein: the respective output is provided by the machine learning model in response to respective input features that are based at least on the information related to the request and data about the respective expert; and the machine learning model has been trained through a supervised learning process based on historical completion times of historical engagements and associated features related to the historical engagements; determining, for each respective expert of the plurality of experts, a respective match score for the support engagement based on the respective estimated completion time for the support engagement for the respective expert and the respective workload capacity of the respective expert; and selecting a given expert of the plurality of experts to handle the support engagement based on the respective match score for the support engagement for each respective expert of the plurality of experts.

Other embodiments provide a method for training a machine learning model. The method generally includes: receiving historical support engagement data comprising records of a plurality of historical support engagements; determining, based on the historical support engagement data, a set of features for a historical support engagement of the plurality of historical support engagements, wherein the set of features comprises: one or more first features related to the historical support engagement; one or more second features related to an expert that handled the historical support engagement; and one or more third features related to the historical support engagement and the expert; determining a label to associate with the set of features, wherein the label indicates a historical completion time of the historical support engagement; providing the set of features for the historical support engagement as inputs to a machine learning model; receiving an output from the machine learning model in response to the inputs; performing a comparison of the output with the label associated with the set of features; and modifying the machine learning model based on the comparison.

Other embodiments provide a system comprising one or more processors and a non-transitory computer-readable medium comprising instructions that, when executed by the one or more processors, cause the system to perform a method. The method generally includes: receiving, from a user, a request for a support engagement comprising information related to the request; receiving, for each respective expert of a plurality of experts, respective workload data comprising information related to current engagements of the respective expert; determining, for each respective expert of the plurality of experts, a respective workload capacity of the respective expert based on the respective workload data for the respective expert; determining, for each respective expert of the plurality of experts, a respective estimated completion time for the support engagement based on a respective output from a machine learning model, wherein: the respective output is provided by the machine learning model in response to respective input features that are based at least on the information related to the request and data about the respective expert; and the machine learning model has been trained through a supervised learning process based on historical completion times of historical engagements and associated features related to the historical engagements; determining, for each respective expert of the plurality of experts, a respective match score for the support engagement based on the respective estimated completion time for the support engagement for the respective expert and the respective workload capacity of the respective expert; and selecting a given expert of the plurality of experts to handle the support engagement based on the respective match score for the support engagement for each respective expert of the plurality of experts.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing environment for expert matching through workload intelligence.

FIG. 2 depicts an example of expert matching through workload intelligence.

FIG. 3 depicts an example user interface related to expert matching through workload intelligence.

FIG. 4 depicts example operations for expert matching through workload intelligence.

FIGS. 5A and 5B depict example processing systems for expert matching through workload intelligence.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for expert matching through workload intelligence.

Embodiments described herein may utilize machine learning techniques to match customers seeking support with experts based on expert-specific estimated completion times and expert-specific workload capacities. In some cases, a machine learning model is trained based on historical support engagements by experts to predict how long an expert with certain attributes (e.g., skills, experience, and the like) will take to complete a prospective support engagement having certain attributes (e.g., relating to a certain product, involving certain issues, being requested by a customer with a certain level of expertise, and the like).

Every historical support engagement by a given expert potentially reveals something about how long it will take experts similar to the given expert to resolve similar support engagements in the future. As such, records of historical support engagements may serve as valuable training data for a machine learning model.

Given a set of training data, a machine learning model can generally generate and refine a function that determines a target attribute value based on one or more input features. For example, if a set of input features describes an automobile and the target value is the automobile's gas mileage, a machine learning model can be trained to predict gas mileage based on the input features, such as the automobile's weight, tire size, number of cylinders, coefficient of drag, and engine displacement.

The predictive accuracy a machine learning model achieves ultimately depends on many factors. Ideally, training data for the machine learning model should be representative of the population for which predictions are desired (e.g., unbiased and correctly labeled). In addition, training data should include a substantive number of training instances relative to the number of features on which predictions are based and relative to the range of possible values for each feature.

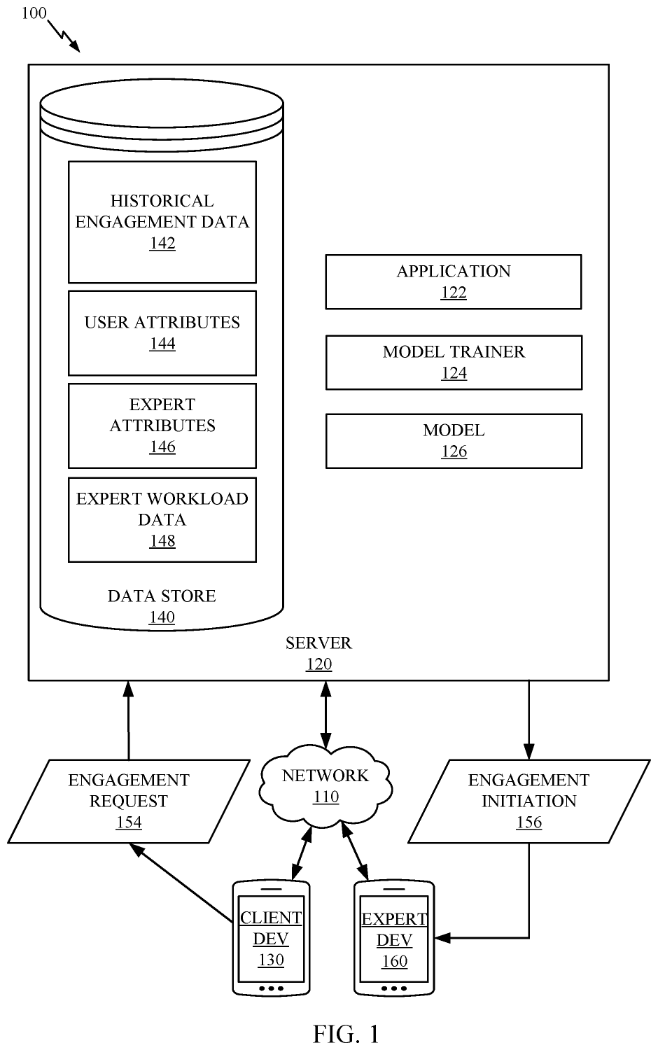

In an example, a training data instance within a training data set may include a set of input features describing an expert and a historical support engagement that the expert completed, and a label for the training data instance may indicate an amount of time that the expert took to resolve the historical support engagement. Training of a machine learning model based on a training data set is described in more detail below with respect to FIG. 1.

Once a machine learning model is trained based on historical support engagements, it may be used to predict how long a given expert will take to resolve a given support engagement that has been requested. For instance, attributes of the given expert and attributes of the given support engagement may be provided as input features to the trained machine learning model, and the model may output a predicted length of time that the given expert will take to resolve the given support engagement.

Furthermore, certain embodiments of the present disclosure involve determining workload capacities of experts based on current engagements of the experts. In an example, for each given expert, predicted completion times are determined for each current engagement of the given expert (e.g., using machine learning techniques or based on statistical or fixed completion times associated with the current engagements). Accordingly, a workload capacity is determined for each expert based on how much time the expert is likely to spend resolving current engagements.

An expert may be selected for a prospective support engagement based on the workload capacities of each expert and the estimated completion time for the prospective support engagement for each expert. In some embodiments, match scores are determined between the prospective support engagement and each expert, and the match scores are used to match an expert to the prospective support engagement. Thus, techniques described herein allow support engagements to be dynamically assigned to experts who are likely to complete the support engagements efficiently and have the workload capacity to do so.

Techniques described herein improve upon existing techniques for automated expert matching in a variety of ways. For example, while existing automated expert matching techniques do not take into account workload capacities of experts, embodiments of the present disclosure utilize workload intelligence to match customers with experts that are likely to have the workload capacity to handle requested engagements. Furthermore, while existing techniques may match customers with experts based on the subject matter of requested engagements, these techniques do not involve a per-expert predicted completion time for the requested engagements, and may result in assigning an engagement to an expert that will not efficiently handle the engagement. Techniques described herein solve this problem by utilizing machine learning techniques to accurately predict a completion time for a requested engagement for each available expert, and, using the predicted completion times along with workload data, to determine match scores for individual experts with respect to the requested engagement.

### Example Computing Environment

FIG. 1 illustrates an example computing environment 100 for expert matching through workload intelligence.

Computing environment 100 includes a server 120, a client device 130, and an expert device 160 connected over network 110. Network 110 may be representative of any type of connection over which data may be transmitted, such as a wide area network (WAN), local area network (LAN), cellular data network, and/or the like.

Server 120 generally represents a computing device such as a server computer. Server 120 includes an application 122, which generally represents a computing application that a user interacts with over network 110 via client device 130. In some embodiments, application 122 is accessed via a user interface associated with client device 130. According to embodiments of the present disclosure, application 122 provides assisted support functionality in which users (e.g., a user of client device 130) are connected with experts (e.g., an expert associated with expert device 160), such as for assistance in resolving issues related to use of application 122. A session in which support is provided to a user by an expert may be referred to herein as a support engagement. Techniques for matching a user's request for a support engagement with an expert may be referred to as expert matching.

A support engagement may be requested by a user in a variety of ways, such as via a phone call, a text message, interaction with one or more user interface elements, a chat session, a voice over internet protocol (VoIP) call, a video call, and the like. While some embodiments involve a user requesting support via the same device with which the user interacts with application 122, other embodiments involve the user requesting support via a different device. For example, the user may interact with application 122 via a desktop computer and may request support via a phone. Furthermore, while some embodiments involve expert matching being performed by the same application 122 about which support is requested, other embodiments involve expert matching being performed by a separate system.

Server 120 includes a model trainer 124, which generally performs operations related to training a model 126 for predicting estimated completion times for particular support engagements with respect to particular experts. Model 126 may, for example, be a machine learning model.

There are many different types of machine learning models that can be used in embodiments of the present disclosure. For example, model 126 may be a boosted tree model, a neural network, a support vector machine, a Bayesian belief network, a regression model, or a deep belief network, among others. Models may also be an ensemble of several different individual machine learning models. Such an ensemble may be homogenous (i.e., using multiple member models of the same type, such as a random forest of decision trees) or non-homogenous (i.e., using multiple member models of different types). Individual machine learning models within such an ensemble may all be trained using the same subset of training data or may be trained using overlapping or non-overlapping subsets randomly selected from the training data.

A tree model (e.g., a decision tree) makes a classification by dividing the inputs into smaller classifications (at nodes), which result in an ultimate classification at a leaf. Boosting, or gradient boosting, is a method for optimizing tree models. Boosting involves building a model of trees in a stage-wise fashion, optimizing an arbitrary differentiable loss function. In particular, boosting combines weak “learners” into a single strong learner in an iterative fashion. A weak learner generally refers to a classifier that chooses a threshold for one feature and splits the data on that threshold, is trained on that specific feature, and generally is only slightly correlated with the true classification (e.g., being at least more accurate than random guessing). A strong learner is a classifier that is arbitrarily well-correlated with the true classification, which may be achieved through a process that combines multiple weak learners in a manner that optimizes an arbitrary differentiable loss function. The process for generating a strong learner may involve a majority vote of weak learners.

A random forest extends the concept of a decision tree model, except the nodes included in any give decision tree within the forest are selected with some randomness. Thus, random forests may reduce bias and group outcomes based upon the most likely positive responses.

A Naïve Bayes classification model is based on the concept of dependent probability i.e., what is the chance of some outcome given some other outcome.

A logistic regression model takes some inputs and calculates the probability of some outcome, and the label may be applied based on a threshold for the probability of the outcome. For example, if the probability is >50% then the label is A, and if the probability is <=50%, then the label is B.

Neural networks generally include a collection of connected units or nodes called artificial neurons. The operation of neural networks can be modeled as an iterative process. Each node has a particular value associated with it. In each iteration, each node updates its value based upon the values of the other nodes, the update operation typically consisting of a matrix-vector multiplication. The update algorithm reflects the influences on each node of the other nodes in the network.

In one example, training data used by model trainer 124 to train model 126 includes sets of features related to historical support engagements associated with labels indicating the amounts of time that were taken to resolve the historical support engagements. Features related to a given historical support engagement may be derived from historical support engagement data 142, and may include, for example, information about a subject of the given historical support engagement (e.g., an identifier, such as a stock-keeping unit (SKU), of a product or service to which the given historical support engagement pertains), attributes of a user that requested the given historical support engagement, attributes of an expert that handled the given historical support engagement, and the like. User attributes may include, for example, experience level (e.g., length of time using the application), subscription type (e.g., basic, deluxe, and/or the like), profession, age, and other details about the user. Expert attributes may include, for example, experience level, skills (e.g., products, services, and/or specific types of issues that the expert is capable of handling), and other details about the expert.

In some embodiments, pairwise features representing both an expert and a support engagement may be derived. For instance, a pairwise feature may indicate whether a given expert has experience with an issue that is particular to a given support engagement or a particular attribute of a user that requested the support engagement (e.g., whether the expert has prior experience assisting independent contractors if the user that requested the support engagement is an independent contractor). In some cases, pairwise features may be generalized so that the model may be trained on pairwise features without being specifically tied to a particular expert or support engagement. An example of a generalized pairwise feature is a binary feature indicating whether or not the expert is experienced in a geographic region of the user. Other types of features may also be derived, such as context-based features. For instance, context-based features may include clickstream data, history of participation in support engagements, manners of requesting support (e.g., voice, video, text, or the like), and the like.

In some embodiments, training model 126 is a supervised learning process that involves providing training inputs (e.g., sets of features) as inputs to model 126. Model 126 processes the training inputs and outputs indications of predicted amounts of time for completing the support engagements represented by the features, with respect to particular experts represented by the features. The outputs are compared to the labels associated with the training inputs to determine the accuracy of model 126, and model 126 is iteratively adjusted until one or more conditions are met.

For example, the conditions may relate to whether the predictions produced by model 126 based on the training inputs match the labels associated with the training inputs or whether a measure of error between training iterations is not decreasing or not decreasing more than a threshold amount. The conditions may also include whether a training interaction limit has been reached. Parameters adjusted during training may include, for example, hyperparameters, values related to numbers of iterations, weights, functions, and the like. In some embodiments, validation and testing are also performed for model 126, such as based on validation data and test data, as is known in the art. Model 126 may be trained through batch training (e.g., each time a threshold number of training data instances have been generated, an amount of time has elapsed, or some other condition is met) and/or through online training (e.g., re-training model 126 with each new training data instance as it is generated).

Data store 140 generally represents a data storage entity such as a database or repository that stores historical engagement data 142, user attributes 144, expert attributes 146, and expert workload data 148. Historical engagement data 142 generally includes records of historical support engagements between users of application 122 and experts. A record of a historical support engagement may include information from which features and a label for the historical support engagement may be derived. For instance, a record may include an amount of time taken to resolve the historical support engagement, information about the user that requested the historical support engagement (e.g., a user identifier that can be used to retrieve attributes of the user from user attributes 144 and/or additional details about the user that can be used to directly derive attributes of the user), information about the expert that handled the historical support engagement (e.g., an expert identifier that can be used to retrieve attributes of the expert from expert attributes 146 and/or additional details about the expert that can be used to directly derive attributes of the expert), information about the engagement itself (e.g., an identifier of a product or service related to the historical support engagement), context data (e.g., clickstream data leading up to a request for support), milestones with associated timestamps, and/or the like. Historical engagement data 142 may be updated over time as new engagements are completed. User attributes 144 include details of users of application 122 associated with user identifiers. Expert attributes 146 include details of experts associated with expert identifiers.

Expert workload data 148 includes data related to availability and current engagements of experts. For a given expert, expert workload data 148 may indicate a total amount of time (e.g., working hours) in which the given expert can handle workloads, how many engagements are currently in progress or scheduled for the given expert, when each current engagement began or is scheduled to begin, information about each current engagement (e.g., identifiers of products or services to which the engagements pertain), information about progress of each current engagement (e.g., milestones completed), and/or the like.

In some embodiments, milestones are standard across engagements, and are indicated by an expert while working on an engagement. For instance, milestones may include “data gathering,” “document preparation,” “document filing,” and the like, and expert may provide input while working on an engagement indicating when a given milestone is complete. In certain embodiments, milestones could be triggered automatically by certain events. For example, after a user has uploaded all data required for a certain engagement, the system could automatically transition from a “data gathering” milestone to a “document preparation” milestone.

For example, after gathering data from a user for a support engagement, the expert may select the “data gathering” milestone (e.g., from a list of standard milestones), and indicate that the milestone is complete.

Milestones may be a useful tool for determining how much longer an expert is likely to take to resolve a given issue. For example, historical engagement data 142 may indicate that for support engagements involving a particular product, completing the data gathering milestone takes on average 30% of the total time taken to resolve the support engagement. If historical engagement data 142 indicates that support engagements involving a particular product have a certain average completion time, then knowing that a certain milestone has been completed may allow for a statistically-sound estimate of the time remaining in a given support engagement involving the particular product. Thus, expert workload data 148 allows for a determination of when experts will be available and how much time they will be able to spend on a new support engagement.

Client device 130 generally represents a computing device such as a mobile phone, laptop or desktop computer, tablet computer, or the like. Client device 130 is used to access application 122 over network 110, such as via a user interface associated with client device 130. In alternative embodiments, application 122 (and, in some embodiments, model 126) is located directly on client device 130. Client device 130 allows a user to request a support engagement and to communicate with an expert during the support engagement, such as to resolve issues related to use of application 122. Client device 130 is representative of a plurality of client devices operated by a plurality of users of application 122.

Expert device 160 generally represents a computing device such as a mobile phone, laptop or desktop computer, tablet computer, or the like. Expert device 160 is operated by an expert in order to participate in support engagements. Expert device 160 is representative of a plurality of expert devices operated by a plurality of experts. Support engagements may include, for example, communication with a user (e.g., via voice, text, and/or video), performing actions to resolve issues (e.g., modifying configuration information, sending files or information, remotely controlling the user's device, and the like), recording notes and milestones, and the like. In some embodiments, engagements may also include work performed by an expert when not connected to a user, such as when competing forms (e.g., filling out a tax filing for the user), documentation, and/or other tasks when not directly interacting with the user.

In one embodiment, an engagement request 154 is sent from client device 130 to server 120, such as in response to a user of client device 130 calling a number, initiating a chat session, clicking on a user interface element, or the like in order to request a support engagement. Engagement request 154 may include information related to the requested support engagement, such as a product identifier (e.g., based on input from the user), a user identifier of the user, context data related to use of application 122 by the user, and the like.

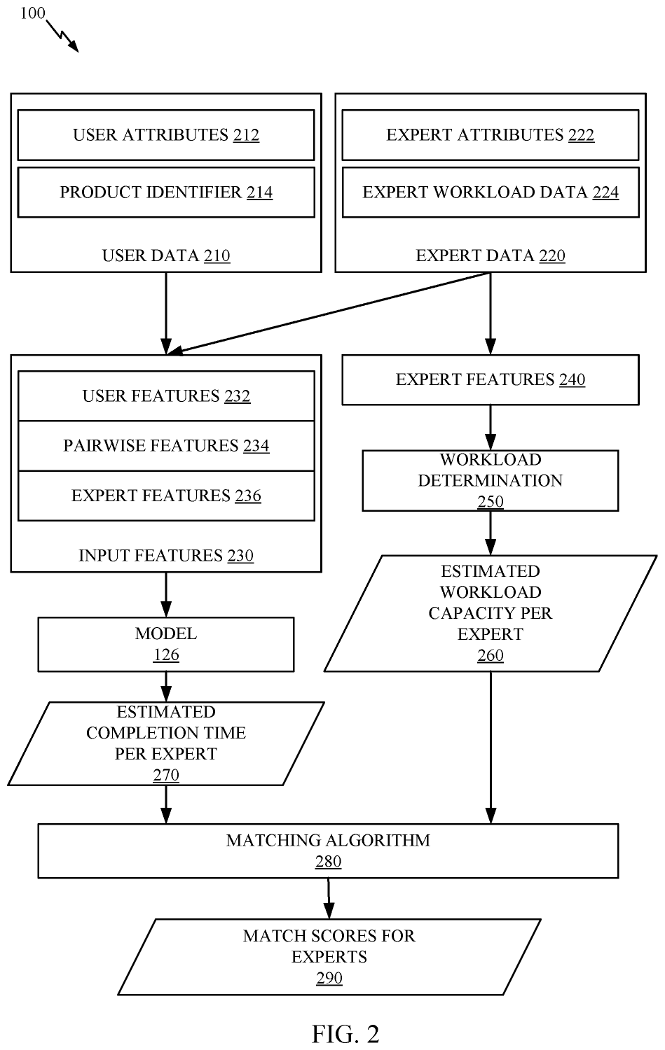

Application 122 receives engagement request 154 and, as explained in more detail below with respect to FIG. 2, performs operations to match engagement request 154 with an expert.

For instance, application 122 may extract features from engagement request 154 and provide inputs to model 126 based on the extracted features, along with features of each of a plurality of experts, in order to determine predicted completion times for the engagement request 154 with respect to each of the plurality of experts. Application 122 may also use expert workload data 148 to determine workload capacities of each of the plurality of experts. Application 122 may then determine a match score between the engagement request 154 and each of the plurality of experts based on the predicted completion times and the workload capacities. Finally, application 122 may select an expert (e.g., the expert operating expert device 160) based on the match scores (e.g., the expert with the highest match score), and an engagement initiation 156 may be sent to expert device 160. The expert operating expert device 160 may then provide support to the user of client device 130 via the support engagement. Details of the support engagement may be saved in expert workload data 148 in association with an identifier of the expert as the support engagement progresses for use in dynamically determining a workload capacity of the expert for future engagement requests. In some embodiments, after the support engagement is complete, a record of the support engagement is saved in historical engagement data 142, and is used to re-train model 126 for improved accuracy.

For example, an actual completion time for the support engagement may be determined, and a training data instance comprising features of the support engagement and the expert associated with a label indicating the actual completion time of the support engagement may be used to re-train the model. Iteratively re-training the model based on actual completion times of support engagements further improves the automated expert matching process by reducing incorrect predictions over time.

### Expert Matching Through Workload Intelligence

FIG. 2 is a block diagram 200 illustrating an example of expert matching through workload intelligence. Block diagram 200 includes model 126 of FIG. 1, and illustrates operations that may, for example, be performed by application 122 of FIG. 1, such as to match engagement request 154 of FIG. 1 with an expert.

User data 210 includes user attributes 212 and a product identifier 214. User data 210 may be determined based on engagement request 154 of FIG. 1 (e.g., from data directly included in the engagement request and/or from user attributes 142 in data store 140 of FIG. 1 based on a user identifier included in the engagement request). In one embodiment, product identifier 214 is a SKU of a product to which the engagement request relates. Expert data 220 includes expert attributes 222 and expert workload data 224 with respect to a plurality of experts. In some embodiments, expert attributes 222 and expert workload data 224 are retrieved from expert attributes 146 and expert workload data 148 in data store 140 of FIG. 1.

User data 210 and expert data 220 are both used to determine input features 230 to provide to model 126. Input features include user features 232, pairwise features 234, and expert features 236. User features 232 represent details about the user requesting support, such as based on user attributes 212. Pairwise features 234 include features that represent both the user and a given expert, such as an indication of whether an expert has experience in the user's geographic region (e.g., city, state, country, or the like), an indication of whether an expert is skilled in subject matter related to the requested support engagement, and the like. Expert features 236 represent details about each expert of the plurality of experts, such as based on expert data 220.

Input features 230 are provided to model 126, which has been trained as described above with respect to FIG. 1. In an embodiment, for each given expert of the plurality of experts, the expert features 236 and pairwise features 234 corresponding to the given expert are provided along with user features 232 as inputs to model 126, and the model outputs an estimated completion time per expert 270. The estimated completion time per expert 270 includes an estimated time that each expert is likely to take to complete the requested support engagement.

Expert data 220 is also used to determine expert features 240 for use in a workload determination 250. Expert features 240 may include information about current engagements of each expert, such as product identifiers and completed milestones of each current engagement of each expert. Workload determination 250 represents a process by which an estimated workload capacity per expert 260 is determined.

In one embodiment, workload determination 250 comprises, for each current engagement of a given expert, determining an average historical completion time for historical support engagements corresponding to the current engagement (e.g., involving the same product identifier) and then determining how much time the given expert is likely to take to complete the current engagement based on the progress of the current engagement (e.g., milestones completed).

In another embodiment, model 126 is used to determine the estimated completion time for each current engagement of each expert rather than using an average historical completion time. Furthermore, an average historical completion time of support engagements involving the same product identifier is included as an example, and other statistical measures may be used to determine the estimated time to complete a given current engagement. The estimated workload capacity per expert 260, determined as a result of workload determination 250, represents an estimated capacity to handle new support engagements for each expert.

In some embodiments, the estimated workload capacity per expert 260 includes an indication of how soon each given expert will be available to begin handling the requested support engagement. In certain embodiments, the estimated workload capacity per expert 260 indicates how much time each given expert has available to potentially work on the requested support engagement, such as within a particular time window (e.g., how many hours in the current day or how many minutes in the current hour an expert has available to potentially handle the requested support engagement).

The estimated completion time per expert 270 and the estimated workload capacity per expert 260 are then used in a matching algorithm 280 in order to determine match scores 290 for the plurality of experts with respect to the requested support engagement. Matching algorithm 280 may involve a calculation of a numerical score (e.g., normalized between 0 and 1) for each expert with respect to the requested support engagement.

In some embodiments, match scores may be determined using a weighted calculation in which workload capacity and estimated completion times are weighted differently. Matching algorithm 280 may, in some embodiments, comprise a greedy algorithm in which experts with the shortest estimated completion times for the requested support engagement and with at least enough workload capacity to complete the requested support engagement (e.g., within a given time window, such as a certain number of minutes or hours from the time the support engagement is requested) are given the highest match scores. In certain embodiments, experts without enough estimated workload capacity (e.g., within a certain time window) to support the estimated completion times corresponding to the experts for the requested support engagement are filtered out prior to match score calculations, while in other embodiments match scores are calculated for all experts.

Match scores 280 are then used to select an expert for the requested support engagement. For example, the expert with the highest (or lowest, in the case that a low match score indicates a higher match) match score may be selected. For example, the expert operating expert device 160 of FIG. 1 may have the highest match score for engagement request 154 of FIG. 1, and so a support engagement may be initiated between client device 130 and expert device 160. The expert may then provide support to the user via the support engagement.

### Example User Interface for Expert Matching Through Workload Intelligence

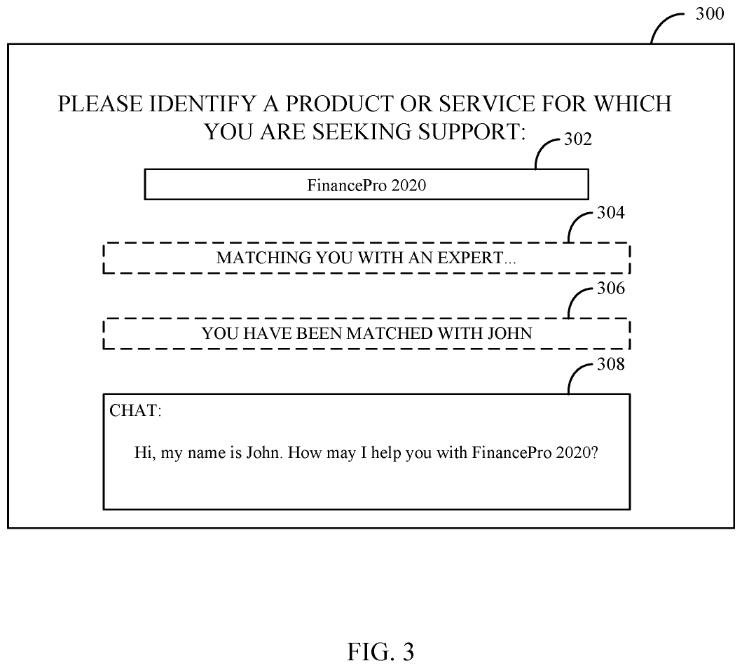

FIG. 3 depicts an example screen 300 of a user interface for expert matching through workload intelligence. For example, screen 300 may be displayed on client device 130 of FIG. 1, and may be displayed after a user selects one or more user interface elements for requesting a support engagement. Screen 300 is included as an example, and other types of user interfaces and modes of initiating support engagements may be utilized with techniques described herein. For example, support engagements may be requested via a phone call.

Screen 300 prompts a user to identify a product or service for which the user is seeking support. At user interface element 302, the user identifies the product “Finance Pro 2020.” In some embodiments, the product “FinancePro 2020” is associated with a SKU. It is noted that additional information may also be solicited from the user via screen 300, such as information about the problem for which the user is seeking support, information about the user, and the like.

At portion 304, screen 300 indicates that the user is being matched with an expert. For example, portion 304 may be displayed while the matching process described above with respect to FIG. 2 is performed.

At portion 306, screen 300 indicates that the user has been matched with an expert named John. For example, the expert named John may have the highest match score for the user's request for a support engagement based on techniques described above with respect to FIG. 2.

User interface element 308 comprises a chat window in which the expert named John begins a conversation with the user in order to provide support, stating: “Hi, my name is John. How may I help you with FinancePro 2020?”

When techniques described herein are utilized to match a user's request for a support engagement with an expert, there may be a high level of confidence that the chosen expert will be able to handle the support engagement effectively and efficiently. Having the highest match score, John is most likely to have workload capacity to handle the support engagement and to complete the support engagement quickly.

### Example Operations for Expert Matching Through Workload Intelligence

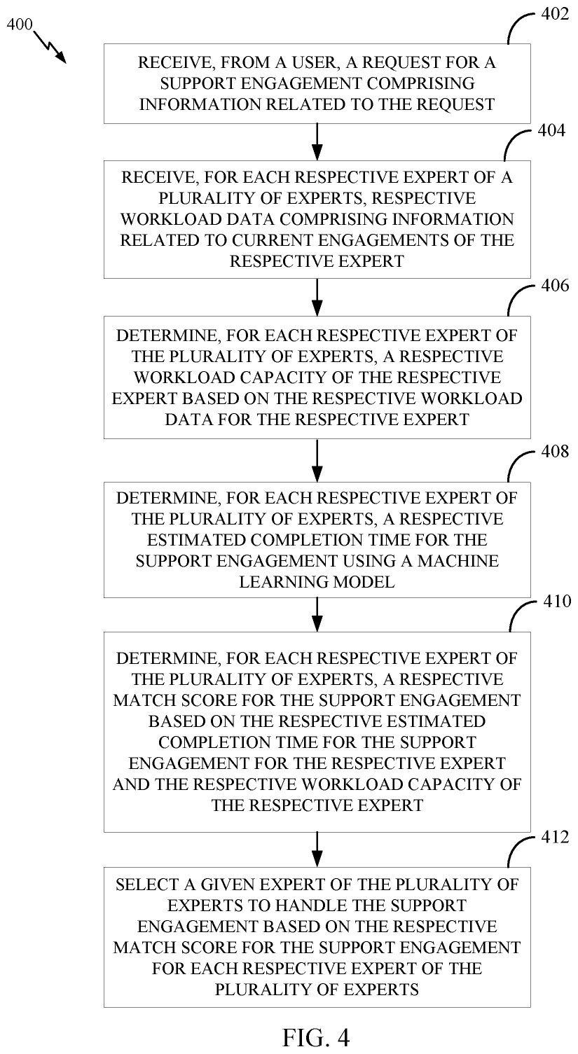

FIG. 4 depicts example operations 400 for expert matching through workload intelligence. For example, operations 400 may be performed by one or more components of server 120, client device 130, and/or expert device 160 of FIG. 1.

At step 402, a request for a support engagement is received from a user, the request comprising information related to the request. The information may include, for instance, a user identifier of the user, an identifier of a product or service to which the support engagement pertains, and/or additional details related to the support engagement.

At step 404, for each respective expert of a plurality of experts, respective workload data is received, the respective workload data comprising information related to current engagements of the respective expert.

At step 406, for each respective expert of the plurality of experts, a respective workload capacity of the respective expert is determined based on the respective workload data for the respective expert. The respective workload capacity may indicate, for example, how much time the respective expert is likely to have available to complete additional support engagements and/or how soon the respective expert is likely to be available to begin the support engagement.

In some embodiments, the estimated workload capacity of an expert is determined by predicting a respective completion time for each respective current support engagement of the expert, such as using the machine learning model and/or based on statistical analysis of historical support engagements. In one example, for each respective support engagement, a total estimated completion time for the respective current engagement is determined, and an estimated remaining completion time for the respective current engagement is determined based on one or more milestones that have been completed for the respective current engagement (in view of the total estimated completion time). The total estimated completion time may be determined based on a product or service related to the respective current engagement, such as by determining an average completion time of historical support engagements related to the product or service.

At step 408, for each respective expert of the plurality of experts, a respective estimated completion time for the support engagement is determined using a machine learning model. In some embodiments, the machine learning model has been trained through a supervised learning process based on features of historical support engagements associated with labels indicating completion times of the historical support engagements.

In some embodiments, input features related to each respective expert and to the support engagement are provided as inputs to the machine learning model, and the estimated completion time is output by the model in response. The input features provided to the machine learning model for each respective expert may include one or more pairwise features related to the respective expert and the support engagement (e.g., which may include attributes of the support engagement and/or the user requesting the support engagement).

At step 410, for each respective expert of the plurality of experts, a respective match score is determined for the support engagement based on the respective estimated completion time for the support engagement for the respective expert and based on the respective workload capacity of the respective expert.

In some cases, experts may be filtered out if they do not have the workload capacity to handle the support engagement. For example, if an expert's estimated completion time for the support engagement is incompatible with the expert's workload capacity, such as because the expert will not be available within a certain time window or because the estimated completion time is too long for the expert to complete the support engagement within an available time window for the expert, the expert may be removed from consideration.

At step 412, a given expert of the plurality of experts is selected to handle the support engagement based on the respective match score for the support engagement for each respective expert of the plurality of experts. For example the expert with the highest or lowest match score may be selected. A support engagement may then be initiated between the user and the selected expert.

In some embodiments, after the support engagement is completed, a record of the support engagement is stored. An actual completion time for the support engagement may be determined, and may be used as a label for a new training data instance for use in re-training the machine learning model. For example, the features related to the expert and the support engagement may be associated with a label indicating the actual completion time for the support engagement in a training data instance that is used to re-train the machine learning model for improved accuracy.

Notably, method 400 is just one example with a selection of example steps, but additional methods with more, fewer, and/or different steps are possible based on the disclosure herein.

### Example Computing Systems

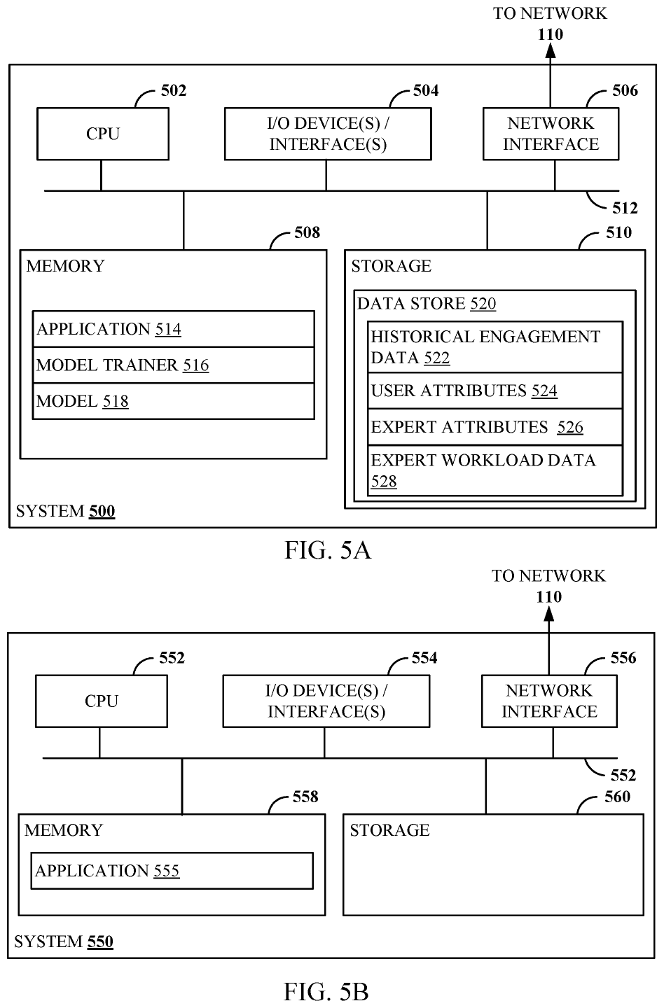

FIG. 5A illustrates an example system 500 with which embodiments of the present disclosure may be implemented. For example, system 500 may be representative of server 120 of FIG. 1.

System 500 includes a central processing unit (CPU) 502, one or more I/O device interfaces 504 that may allow for the connection of various I/O devices 514 (e.g., keyboards, displays, mouse devices, pen input, etc.) to the system 500, network interface 506, a memory 508, storage 510, and an interconnect 512. It is contemplated that one or more components of system 500 may be located remotely and accessed via a network. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, memory 508, and storage 510. CPU 502 is included to be representative of a single CPU, multiple CPUs, a single CPU having multiple processing cores, and other arrangements.

Additionally, the memory 508 is included to be representative of a random access memory. As shown, memory 508 includes application 514, model trainer 516, and model 518, which may be representative of application 122, model trainer 124, and model 126 of FIG. 1.

Storage 510 may be a disk drive, solid state drive, or a collection of storage devices distributed across multiple storage systems. Although shown as a single unit, the storage 510 may be a combination of fixed and/or removable storage devices, such as fixed disc drives, removable memory cards or optical storage, network attached storage (NAS), or a storage area-network (SAN).

Storage 510 comprises data store 520, which may be representative of data store 140 of FIG. 1. While data store 520 is depicted in local storage of system 500, it is noted that data store 520 may also be located remotely (e.g., at a location accessible over a network, such as the Internet). Data store 520 includes historical engagement data 522, user attributes 524, expert attributes 526, and expert workload data 528, which may be representative of historical engagement data 142, user attributes 144, expert attributed 146, and expert workload data 148 of FIG. 1.

FIG. 5B illustrates another example system 550 with which embodiments of the present disclosure may be implemented. For example, system 550 may be representative of client device 130 and/or expert device 160 of FIG. 1.

System 550 includes a central processing unit (CPU) 552, one or more I/O device interfaces 554 that may allow for the connection of various I/O devices 554 (e.g., keyboards, displays, mouse devices, pen input, etc.) to the system 550, network interface 556, a memory 558, storage 560, and an interconnect 562. It is contemplated that one or more components of system 550 may be located remotely and accessed via a network. It is further contemplated that one or more components of system 550 may comprise physical components or virtualized components.

CPU 552 may retrieve and execute programming instructions stored in the memory 558. Similarly, the CPU 552 may retrieve and store application data residing in the memory 558. The interconnect 562 transmits programming instructions and application data, among the CPU 552, I/O device interface 554, network interface 556, memory 558, and storage 560. CPU 552 is included to be representative of a single CPU, multiple CPUs, a single CPU having multiple processing cores, and other arrangements.

Additionally, the memory 558 is included to be representative of a random access memory. As shown, memory 558 includes an application 555, which may be representative of a client-side component corresponding to the server-side application 514 of FIG. 5A. For example, application 555 may comprise a user interface through which a user of system 550 interacts with application 514 of FIG. 5A. In alternative embodiments, application 555 is a standalone application that performs expert matching as described herein.

Storage 560 may be a disk drive, solid state drive, or a collection of storage devices distributed across multiple storage systems. Although shown as a single unit, the storage 510 may be a combination of fixed and/or removable storage devices, such as fixed disc drives, removable memory cards or optical storage, network attached storage (NAS), or a storage area-network (SAN).

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for expert matching through workload intelligence, comprising:
receiving, from a user, a request for a support engagement comprising information related to the request;
receiving, for each respective expert of a plurality of experts, respective workload data comprising information related to current engagements of the respective expert;
determining, for each respective expert of the plurality of experts, a respective workload capacity of the respective expert based on the respective workload data for the respective expert;
determining, for each respective expert of the plurality of experts, a respective estimated completion time for the support engagement based on a respective output from a machine learning model, wherein;
the respective output is provided by the machine learning model in response to respective input features that are based at least on the information related to the request and data about the respective expert; and
the machine learning model has been trained through a supervised learning process based on historical completion times of historical engagements and associated features related to the historical engagements;
determining, for each respective expert of the plurality of experts, a respective match score for the support engagement based on the respective estimated completion time for the support engagement for the respective expert and the respective workload capacity of the respective expert; and
selecting a given expert of the plurality of experts to handle the support engagement based on the respective match score for the support engagement for each respective expert of the plurality of experts.

2. The method of claim 1, wherein determining, for each respective expert of the plurality of experts, the respective workload capacity of the respective expert based on the respective workload data for the respective expert comprises:
determining one or more current support engagements of the respective expert; and
predicting a respective completion time for each respective current support engagement of the one or more current support engagements.

3. The method of claim 2, wherein predicting the respective completion time for each respective current support engagement of the one or more current support engagements comprises:
determining a total estimated completion time for the respective current engagement;
determining that one or more milestones have been completed for the respective current engagement; and
determining an estimated remaining completion time for the respective current engagement based on the total estimated completion time for the respective current engagement and the one or more completed milestones.

4. The method of claim 3, wherein determining that the one or more milestones have been completed for the respective current engagement comprises:
determining that the one or more milestones have been automatically triggered; or
determining that the one or more milestones have been indicated by the respective expert.

5. The method of claim 3, wherein determining the total estimated completion time for the respective current engagement comprises:
providing features of the respective current engagement as inputs to the machine learning model; and
receiving the total estimated completion time for the respective current engagement as an output from the model.

6. The method of claim 3, wherein determining the total estimated completion time for the respective current engagement comprises:
determining a product or service related to the respective current engagement; and
determining an average completion time of a plurality of historical support engagements related to the product or service.

7. The method of claim 1, wherein the respective input features provided to the machine learning model for each respective expert comprise one or more pairwise features related to the respective expert and the support engagement.

8. The method of claim 1, further comprising filtering a particular expert from the plurality of experts based on a determination that the estimated completion time for the support engagement for the particular expert is incompatible with the respective workload capacity of the particular expert.

9. The method of claim 1, further comprising:
determining an actual completion time for the support engagement; and
re-training the machine learning model based on the actual completion time, the information related to the request, and data about the respective expert.

10. A method for training a machine learning model, comprising:
receiving historical support engagement data comprising records of a plurality of historical support engagements;
determining, based on the historical support engagement data, a set of features for a historical support engagement of the plurality of historical support engagements, wherein the set of features comprises:
one or more first features related to the historical support engagement;
one or more second features related to an expert that handled the historical support engagement; and
one or more third features related to the historical support engagement and the expert;
determining a label to associate with the set of features, wherein the label indicates a historical completion time of the historical support engagement;
providing the set of features for the historical support engagement as inputs to a machine learning model;
receiving an output from the machine learning model in response to the inputs;
performing a comparison of the output with the label associated with the set of features; and
modifying the machine learning model based on the comparison.

11. The method of claim 10, further comprising:
after training the machine learning model, determining a completion time of a subsequent support engagement; and
re-training the machine learning model based on the completion time of the subsequent support engagement.

12. A system, comprising: one or more processors; and a memory comprising instructions that, when executed by the one or more processors, cause the system to perform a method for expert matching through workload intelligence, the method comprising:
receiving, from a user, a request for a support engagement comprising information related to the request;
receiving, for each respective expert of a plurality of experts, respective workload data comprising information related to current engagements of the respective expert;
determining, for each respective expert of the plurality of experts, a respective workload capacity of the respective expert based on the respective workload data for the respective expert;
determining, for each respective expert of the plurality of experts, a respective estimated completion time for the support engagement based on a respective output from a machine learning model, wherein;
the respective output is provided by the machine learning model in response to respective input features that are based at least on the information related to the request and data about the respective expert; and
the machine learning model has been trained through a supervised learning process based on historical completion times of historical engagements and associated features related to the historical engagements;
determining, for each respective expert of the plurality of experts, a respective match score for the support engagement based on the respective estimated completion time for the support engagement for the respective expert and the respective workload capacity of the respective expert; and
selecting a given expert of the plurality of experts to handle the support engagement based on the respective match score for the support engagement for each respective expert of the plurality of experts.

13. The system of claim 12, wherein determining, for each respective expert of the plurality of experts, the respective workload capacity of the respective expert based on the respective workload data for the respective expert comprises:
determining one or more current support engagements of the respective expert; and
predicting a respective completion time for each respective current support engagement of the one or more current support engagements.

14. The system of claim 13, wherein predicting the respective completion time for each respective current support engagement of the one or more current support engagements comprises:
determining a total estimated completion time for the respective current engagement;
determining that one or more milestones have been completed for the respective current engagement; and
determining an estimated remaining completion time for the respective current engagement based on the total estimated completion time for the respective current engagement and the one or more completed milestones.

15. The system of claim 14, wherein determining that the one or more milestones have been completed for the respective current engagement comprises:
determining that the one or more milestones have been automatically triggered; or
determining that the one or more milestones have been indicated by the respective expert.

16. The system of claim 14, wherein determining the total estimated completion time for the respective current engagement comprises:
providing features of the respective current engagement as inputs to the machine learning model; and
receiving the total estimated completion time for the respective current engagement as an output from the model.

17. The system of claim 14, wherein determining the total estimated completion time for the respective current engagement comprises:
determining a product or service related to the respective current engagement; and
determining an average completion time of a plurality of historical support engagements related to the product or service.

18. The system of claim 12, wherein the respective input features provided to the machine learning model for each respective expert comprise one or more pairwise features related to the respective expert and the support engagement.

19. The system of claim 12, wherein the method further comprises filtering a particular expert from the plurality of experts based on a determination that the estimated completion time for the support engagement for the particular expert is incompatible with the respective workload capacity of the particular expert.

20. The system of claim 12, wherein the method further comprises:
determining an actual completion time for the support engagement; and
re-training the machine learning model based on the actual completion time, the information related to the request, and data about the respective expert.
